(19) United States
(12) Patent Application Publication
(10) Pub. No.: US 2008/0098082 A1
(43) Pub. Date: Apr. 24, 2008

(54) Systems and methods for data transfer

(75) Inventors: An-Sheng Chang, Taipei Hsien (TW); Teng-Chieh Liu, Taipei Hsien (TW)

Correspondence Address: BIRCH STEWART KOLASCH & BIRCH, PO BOX 747, FALLS CHURCH, VA, 22040-0747, US

(73) Assignee: GIGA-BYTE TECHNOLOGY CO., LTD.

(21) Appl. No.: 11/582,364

(22) Filed: Oct. 18, 2006

(51) Int. Cl. G06F 9/44; G06F 15/16

(52) U.S. Cl. 709/217; 717/173; 709/219

(57) ABSTRACT

A computer system is disclosed. The system comprises a connection interface, a download device and at least one first computer device. The first computer device generates a script file. The download device, coupled to the first computer device via the connection interface, comprises a processing unit, a network interface and a storage unit. When the download device and the first computer device are disconnected, the processing unit is capable of finding and performing at least one corresponding download instruction according to the content of the script file. Downloaded data is then stored in the storage unit.

### BACKGROUND OF THE INVENTION

1. Field of the Invention

The invention relates to a system and method for data transfer, and in particular, to a computer system and method for performing peer-to-peer (P2P) data transfer.

2. Description of the Related Art

Data transferring between computers is commonly employed in current network applications. A peer-to-peer (P2P) data transfer provides high speeds, supporting various data types and multiple users, and thus has become popular. Generally, when performing P2P data transfer, a computer device, such as a personal computer (PC) or a notebook, requires a script file denoting length, name, and hashing information of a desired file, and the uniform resource locator (URL) of a tracker. For example, to download a file from a network through BitTorrent™, a website is searched to locate and download a torrent file (with extension torrent), after which the file is opened in a BitTorrent (BT) client in the destination device, whereupon the BT client downloads the desired file from a seeder and/or peers through the Internet. When the downloaded file, e.g. a multimedia file, is large, due to the limitation of the network bandwidth, the computer device performing P2P data transfer must remain on throughout the transfer, consuming considerable power. In addition, the downloaded file is only stored in the computer device with the executed BT client, making data sharing inconvenient between different computer devices.

### BRIEF SUMMARY OF THE INVENTION

The invention provides a computer system with an isolated download device relocating task execution with longer processing time to a download device.

An exemplary embodiment of a computer system comprises a connection interface, a download device and at least one first computer device. The first computer device generates a script file. The download device, coupled to the first computer device through the connection interface, comprises a processing unit, a network interface and a storage unit. When the download device and the first computer device are disconnected, the processing unit is enabled to locate and execute at least one corresponding download instruction in the storage unit according to the content of the script file, generating and storing downloaded data in the storage unit after the download instruction is completed.

The invention also provides a data transfer method comprising a first computer device generating a script file, executing a corresponding download instruction from a download device according to the content of the script file; and storing downloaded data from a network in the download device according to the content of the script file after the download instruction is completed.

### BRIEF DESCRIPTION OF THE DRAWINGS

The invention can be more fully understood by reading the subsequent detailed description and examples with reference to the accompanying drawings, wherein:

FIG. 1 is a schematic illustration of a computer system according to an embodiment of the invention;

FIG. 2 is a flowchart of data transfer method applied in a computer device according to an embodiment of the invention;

FIG. 3 is a flowchart of a data transfer method applied in a download device according to an embodiment of the invention;

FIG. 4 is a schematic illustration of a data sharing method according to an embodiment of the invention;

FIG. 5 is a schematic illustration of a computer system according to another embodiment of the invention;

FIG. 6 is a flowchart of a data transfer method applied in a computer device according to another embodiment of the invention; and

FIG. 7 is a flowchart of a data transfer method applied in a download device according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

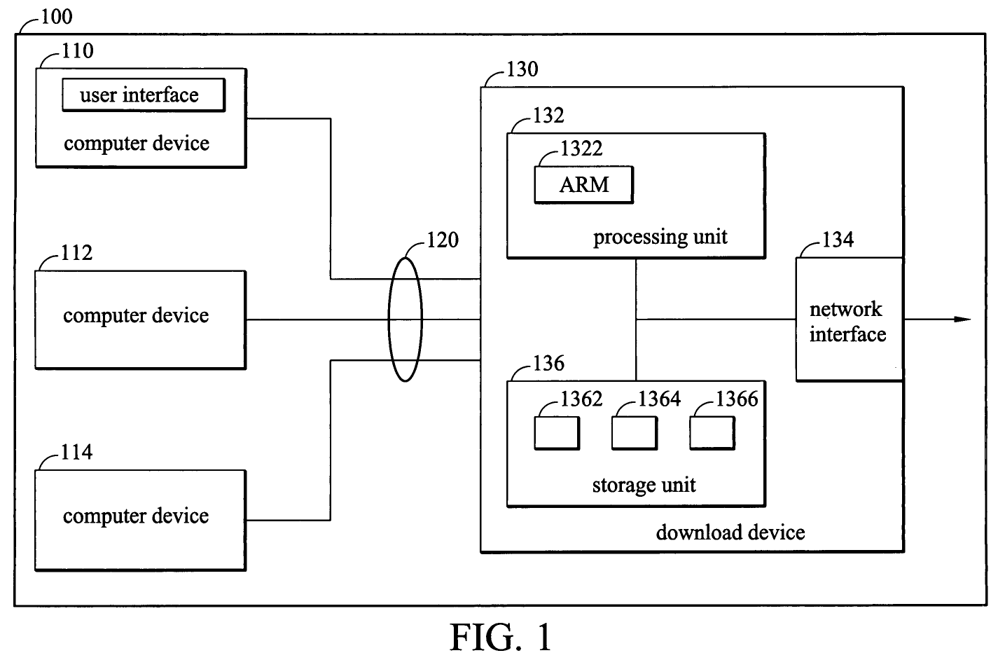

FIG. 1 shows an embodiment of a computer system according to the invention. Computer system 100 comprises computer devices 110, 112 and 114, and a download device 130. Computer devices 110, 112 and 114 are respectively coupled to the download device 130 through a connection interface 120. In this embodiment, the connection interface 120 may be a wired network interface, such as Ethernet network interface (LAN), a wireless network interface, such as 802.11a/b/g network interface (WLAN), or USB interface, providing data sharing or transfer between computer devices 110, 112 and 114 and the download device 130. Each computer device has a user interface enabling creation, modification, or review of script files.

The download device 130, coupled to the computer devices through the connection interface 120, comprises a processing unit 132, a network interface 134 and a storage unit 136. The processing unit 132 performs assigned tasks and initiates a corresponding download instruction. The network interface 134 may be a wired or wireless network interface connected to a physical network, e.g. Internet, such that the download device 130 can download specific data or files therefrom. The storage unit 136 comprises instructions for a download instruction that, executed with a script file, enable the download device to download from the physical network files denoted in the script file. After the download instruction is completed, the complete file is also stored in storage unit 136. The download instruction comprises one or more programs capable of performing the task assigned by the script file. For example, the download instruction can be a program, such as a BT client, capable of performing P2P download. In one example, assuming that computer device 110 provides a BT script file and the storage unit 136 of the download device 130 stores the execution file of a corresponding BT program, download device 130 may perform an assigned download instruction based on the content of the BT script file. In this embodiment, the storage device 136 may comprise any kind of storage media, such as a FLASH memory 1362, a SRAM 1364, a hard disk 1366, and the like. The FLASH memory 1362 may have an embedded system therein for memory management and task scheduling, and the hard disk 1366 may comprise a plurality of download instructions. When receiving a script file, the download device 130 starts to find a corresponding download instruction (in an executable file) from the hard disk 1366 according to the script file, loads the corresponding download instruction to SRAM 1364 for execution, and then starts downloading the file described in the script file. After download completion, the file (referred to as downloaded data) is then stored in the hard disk 1366. Download instructions and downloaded file may be stored in the same or different hard disks.

It should be noted that the processing unit 132 may be a system on programmable chip (SOPC) that has modules or elements programmable to perform a required task. For example, the processing unit 132 may comprise a microprocessor (e.g. an ARM processor) 1322, a memory controller (not shown), a USB controller (not shown) and an input/output port controller (not shown), coupled together by an internal bus to control access to storage units. Moreover, the processing unit 132 may also comprise specific intellectual property (IP) modules to perform specific tasks.

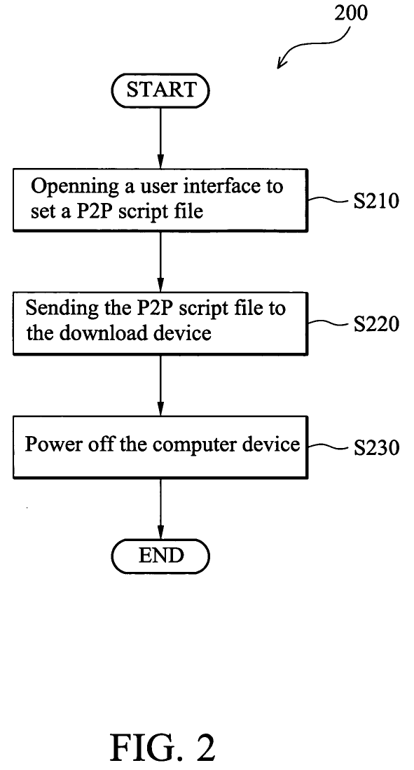

FIG. 2 shows an embodiment of a data transfer method applied in a computer device according to the invention. It should be noted that the request of the data transfer may be sent from any of the computer devices 110, 112 or 114. In this embodiment, the request for data transfer is sent from the computer device 110. In response, a user interface is first opened to set a download profile (step S210). The user interface is then closed and the download profile stored in a script file SF. The script file SF is sent to the download device 130 by the computer device 110 (step S220). If no additional tasks are to be performed, the computer device 110 can be powered off (step S230) and thus disconnected from the download device 130, remaining offline.

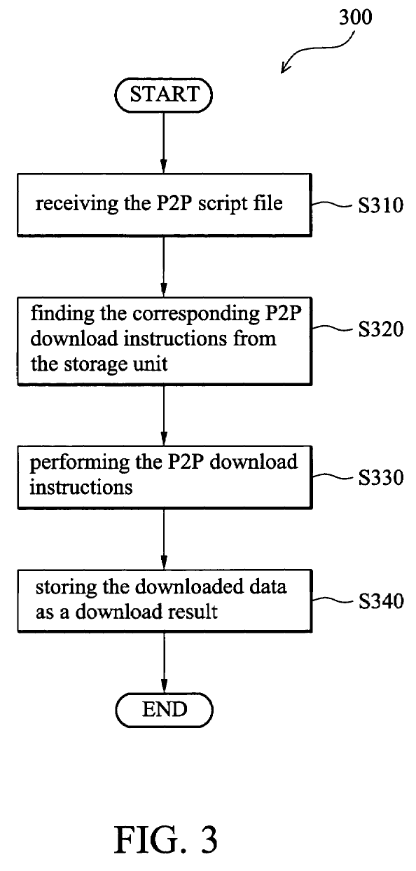

FIG. 3 shows an embodiment of a data transfer method applied in a download device according to the invention. The method can be performed while the computer device 110 and the download device 130 are disconnected. Script file SF sent from the computer device 110 is received by the download device 130 (step S310). After receiving the script file SF, based on the script file SF, the processing unit of the download device 130 determines that it is a P2P download request, and locates the corresponding P2P download instruction within the storage unit 136 (step S320), which are then initiated (step S330). Accordingly, the download device 130 downloads from the connected network dedicated data (file) as directed in the script file SF. Resulting downloaded data is stored in the storage unit 136 (step S340).

Referring to both FIG. 2 and FIG. 3, for execution of a download instruction, the computer 110 sets only the download profiles and generates a script file which is then sent to the download device 130 for actual execution, such that the computer device 110 can be powered off prior to completion of the download instruction. Power consumption is thus reduced significantly.

Downloaded data is stored in storage unit 136 of the download device 130. Other computer devices, such as computer device 112 or 114 of FIG. 1, can easily request and acquire the downloaded data from the storage unit 136 of the download device 130 if desired.

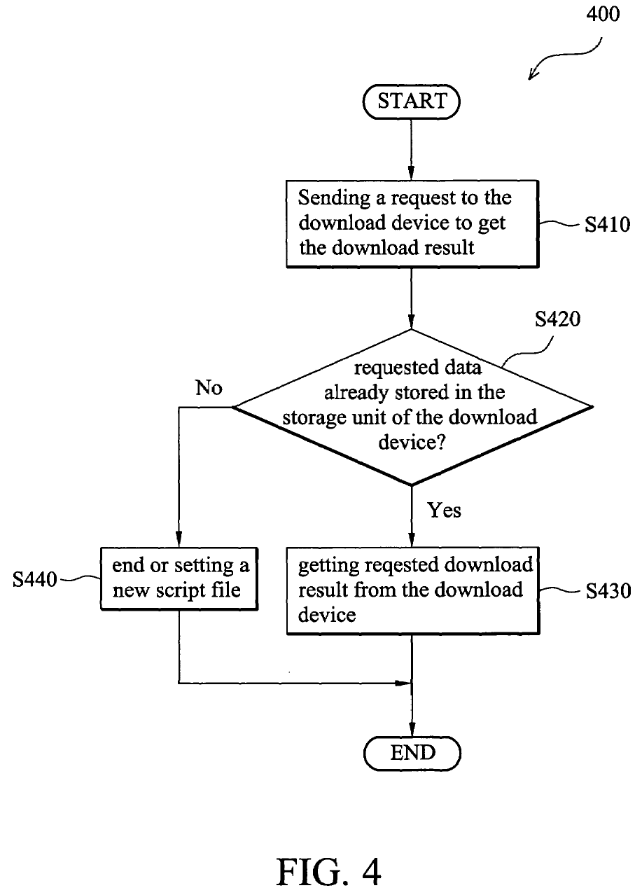

FIG. 4 shows an embodiment of a data sharing method according to the invention. As shown, when the computer device 112 is to download data, according to the content of the script file SF, a request is first sent to the download device 130 (step S410). The download device 130 then determines whether the requested data is already present in the storage unit (step S420). If so (Yes in step S420), the download device 130 returns confirmation to the computer device 112 and transfers the data to the computer device 112 via the connection interface 120 (step S430). If the data is not located (No in step S420), the download device 130 returns a rejection to the computer device 112. Upon receipt of the rejection, the computer device 112 may terminate the communication or provide a new script file requesting a new download instruction to the download device 130 using the method of FIG. 2 (step S440). Similarly, computer device 114 may also acquire the same data via steps S410-S440. All computer devices within a system can thus easily share data.

In addition, the computer system, according to the invention, may execute other tasks requiring longer processing time while conserving power by similarly relocating such operations to the download device. For example, digital video broadcast (DVB) recording can be relocated to the download device, when applicable hardware or modules therefor are incorporated into the download device.

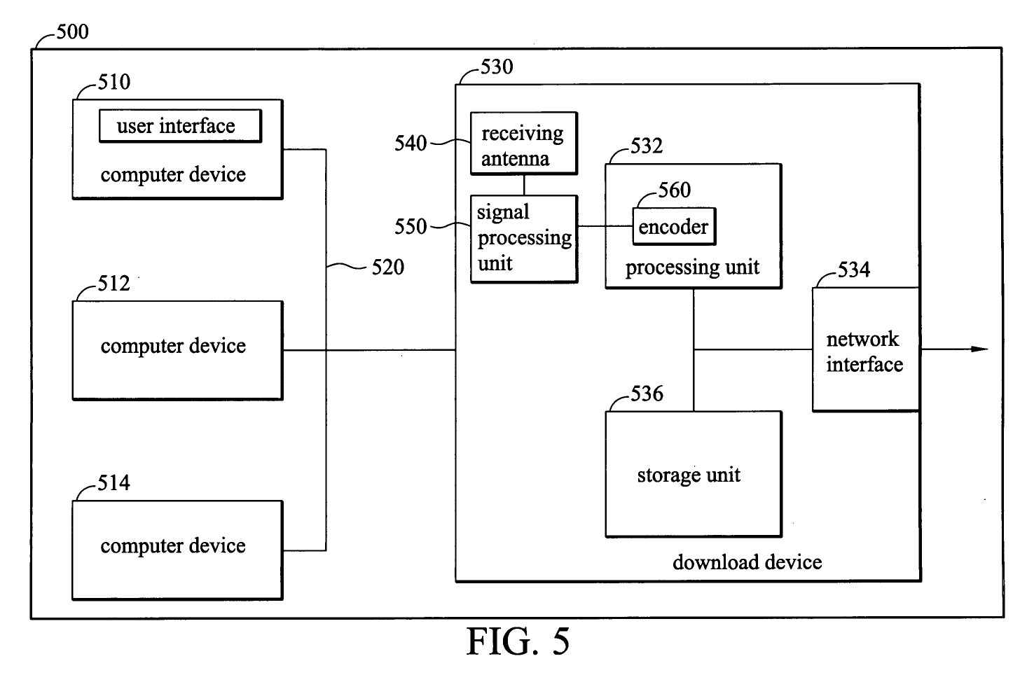

FIG. 5 shows an embodiment of another computer system 500 according to the invention, comprising three computer devices 510, 512 and 514, a connection interface 520 and a download device 530. Computer devices 510, 512 and 514, connection interface 520 and download device 530 are similar to the computer devices 110, 112 and 114, connection interface 120 and download device 130 of the FIG. 1, respectively, differing only in that one receiving antenna 540, one signal processing unit 550 and one encoder 560 are present in download device 530 to receive and process DVB signals. DVB signals are first received by the receiving antenna 540, then decoded by the signal processing unit 550, and encoded to a recordable signal format by encoder 560. Encoder 560 can be configured externally or internally according to the processing device and hardware design. It should be noted that the corresponding download instruction for DVB recording is stored in the storage unit of the download device, which then executes the download instruction to perform the DVB recording when a corresponding request is received. Signal processing unit 550 may comprise different signal processing modules based on system requirements. In some embodiments, for example, the signal processing unit 550 may comprise a DVB signal processing module or a cable TV signal processing module.

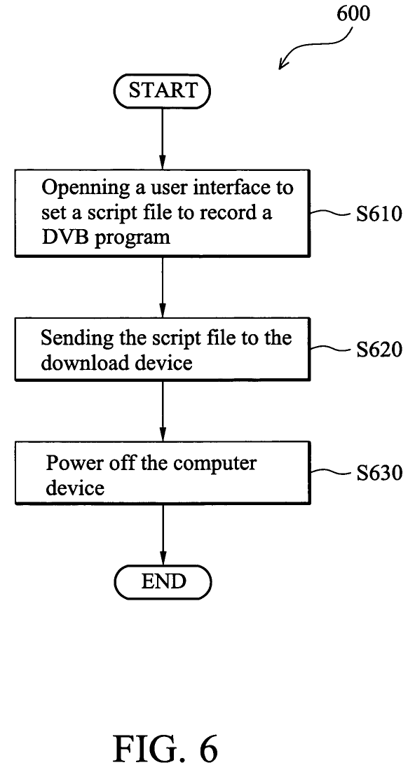

FIG. 6 shows another embodiment of a data transfer method applied in a computer device according to the invention, with the request for data transfer a DVB recording request, which may be sent from any of computer devices 510, 512 or 514. In this embodiment, the request originates with computer device 510. A user interface is opened to set the DVB profile including information for the DVB (e.g. channel number, recording start or end time) to be recorded (step S610). After the setting is completed, the user interface is closed and the DVB profile is stored in a script file SF2, which includes the channel and time information of the recording. The script file SF2 is then sent to the download device 530 by the computer device 510 (step S620). Computer device 510 can then be powered off if no further operations are to be performed (step S630), such that the computer device 510 and the download device 530 are disconnected, with computer device 510 offline, correspondingly.

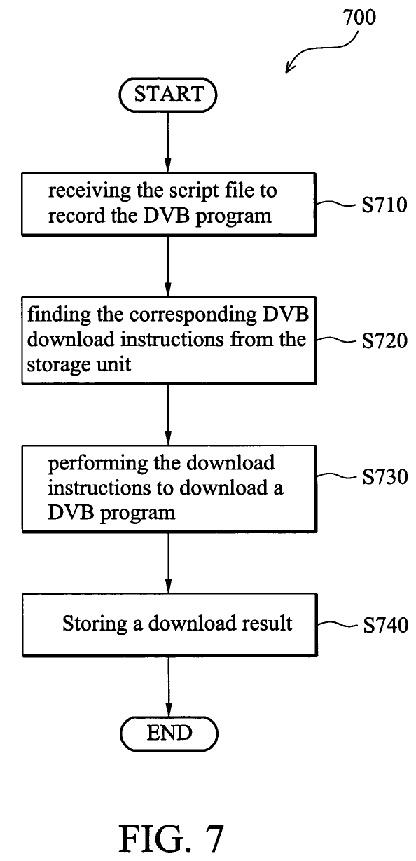

FIG. 7 shows another embodiment of a data transfer method applied in a download device side according to the invention, applicable with computer device 510 and download device 530 disconnected. Script file SF2 from the computer device 510 is received by the download device 530 (step S710). Upon receipt of script file SF2, based on the content of the script file, the processing unit of the download device 530 determines that the request is for a DVB recording, and locates the corresponding DVB recording download instruction within the storage unit 536 (step S720), which are then executed (step S730). Accordingly, the download device 530 receives and records the DVB according to the content of the script file SF2 through the receiving antenna 540, the signal processing unit 550 and the encoder 560. When the download instruction is completed, the downloaded DVB program, is stored in the storage unit 536 (step S740), whereby all computer devices within the computer system 500 may share the stored DVB.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A computer system, comprising:
at least one first computer device generating a script file;
a connection interface; and
a download device coupled to the first computer device through the connection interface, comprising:
a processing unit;
a network interface; and
a storage unit;
wherein, when the download device and the first computer device are disconnected, the processing unit can execute at least one download instruction in the storage unit according to the content of the script file, generating and storing downloaded data in the storage unit after the download instruction is completed.

2. The computer system as claimed in claim 1, wherein the first computer device further comprises a user interface generating the script file.

3. The computer system as claimed in claim 1, wherein the system further comprises a plurality of computer devices accessing the download result through the connection interface.

4. The computer system as claimed in claim 1, wherein the network interface further comprises wired and wireless network interfaces.

5. The computer system as claimed in claim 1, wherein the processing unit is a SOPC (system on programmable chip).

6. The computer system as claimed in claim 5, wherein the SOPC further comprises an ARM processor.

7. The computer system as claimed in claim 1, wherein the download device further comprises:
a receiving antenna receiving a DVB (digital video broadcasting) program signal; and
a signal processing unit processing the received DVB signal.

8. The computer system as claimed in claim 7, wherein the signal processing unit further comprises a DVB signal processing module.

9. The computer system as claimed in claim 7, wherein the signal processing unit further comprises a cable TV signal processing module.

10. The computer system as claimed in claim 1, wherein the download instruction is a P2P (peer to peer) download instruction.

11. The computer system as claimed in claim 1, wherein the download instruction is a DVB recording download instruction.

12. The computer system as claimed in claim 1, wherein the connection interface is a USB or network interface.

13. The computer system as claimed in claim 1, wherein the storage unit comprises a SRAM, a FLASH memory and a hard disk.

14. A data transfer method, comprising:
a first computer device generating a script file;
locating and performing a corresponding download instruction in a download device according to the content of the script file when the download device and the first computer device are disconnected; and
storing downloaded data from a network in the download device after the download instruction is completed.

15. The data transfer method as claimed in claim 14, further comprising powering off the first computer device after the first computer device sends the script file.

16. The data transfer method as claimed in claim 14, further comprising accessing the download result by at least one second computer.

17. The data transfer method as claimed in claim 14, further comprising providing an user interface to generate the script file.

18. The data transfer method as claimed in claim 14, further comprising performing P2P download instruction if the script file is a P2P script file, and performing DVB recording download instruction if the script file is a DVB recording script file.

19. The data transfer method as claimed in claim 14, wherein a processing unit of the download device performs the download instruction, and the corresponding download instruction and the download result are stored in a storage unit of the download device.
